(19) United States
(12) Patent Application Publication
(10) Pub. No.: US 2007/0159308 A1
(43) Pub. Date: Jul. 12, 2007

(54) Warning alarm system for retractable motor vehicle steps

(76) Inventor: John Johnston, Jupiter, FL (US)

Correspondence Address: MCHALE & SLAVIN, P.A., 2855 PGA BLVD, PALM BEACH GARDENS, FL, 33410, US

(21) Appl. No.: 11/332,600

(22) Filed: Jan. 10, 2006

(51) Int. Cl. B60Q 1/00; G08B 21/00; G08B 19/00; G08B 1/08

(52) U.S. Cl. 340/425.5; 340/686.1; 340/521; 340/539.1

(57) ABSTRACT

A retractable step alarm in a motor vehicle or trailer which includes a processor coupled to an alarm, a door sensor, vehicle operation sensors, and extended and retracted step position sensors. The alarm is activated by an enable signal sent by the processor. The extended step position sensor is positioned to detect if the steps are fully extended and the retracted step position sensor is positioned to detect if the steps are fully retracted. The processor activates the alarm means if the vehicle operation sensor indicates that the vehicle ignition is on and/or the transmission is engaged, indicative that the vehicle is bound for movement, and the retracted step position sensor indicates the steps are not fully retracted, or if the door sensor indicates the door is open and the extended step position sensor indicates the steps are not fully extended. The processor also activates the alarm means if both the extended or retracted door sensor signals are low for more than ten seconds indicating that the step is stuck partially extended or retracted and the processor activates the alarm means if both the extended or retracted door sensor signals are high indicating the step is fully retracted and extended at the same time thus indicating one or both step position sensors or wiring has failed or is damaged.

### FIELD OF THE INVENTION

The present invention relates to a warning alarm system for retractable vehicle steps, and more particularly to a warning system, which can be used in a vehicle such as a motor home or an RV in combination with either manual, or automatic step deployment systems.

### BACKGROUND OF THE INVENTION

Recreational vehicles, motor homes, travel trailers, sport utility vehicles and the like have passenger areas which are a considerable elevation from the ground surface, making it desirable to include some type of step structure for the convenience of the passengers. Vehicles usually include a retractable step unit mounted beneath the door, which can be extended when needed and retracted to a storage position when not in use, or the vehicle is in motion. Vehicle steps are sometimes constructed for manual operation, however it is well known in the art to provide motorized retractable step systems. Motorized step deployment systems can be either manually actuated or configured for fully automatic deployment.

The retractable can steps create a potential hazard because errors in deployment can cause serious accidents. If the vehicle door is opened without the steps in place, a person may unthinkingly exit the door without looking and fall to the ground. Driving or towing the vehicle with the steps extended can easily damage both the vehicle and other property.

Manually actuated or manually actuated motorized steps are subject to human error and may be improperly deployed if care is not taken. Automatically deployable steps eliminate the human error factor to an extent, but may provide a false sense of security since accidents may occur if the system malfunctions. Thus, an alarm system for potentially hazardous situations, which functions independently of the step deployment system, would be highly desirable.

### DESCRIPTION OF THE PRIOR ART

U.S. Pat. No. 6,178,364 discloses a method and apparatus for automatic deployment and retraction of a retractable stairway in a tractor trailer cab. The system monitors whether a vehicle is stopped, whether the parking brake is set, whether the cab is tilted in excess of a threshold, and whether excess current is being required to shift the stairway. In the event that any of these conditions are not in a predetermined state, deployment of the stairway from a stowed position is blocked. Interior and exterior alarm devices may be activated.

U.S. Pat. No. 5,547,040, to Hanser et al. discloses an automatic entryway step system for recreational vehicles and motor homes, which extends and retracts steps in response to a momentary push button switch located inside the vehicle near the door. A safety retraction system automatically retracts the step when the vehicle ignition is turned on, but only if the vehicle brake is not engaged. If the vehicle's ignition system is turned on while the parking brake is engaged, a step warning indicator will be activated to alert the driver that the step is extended.

U.S. Pat. No. 3,883,884 discloses a remote signal means operable connected between a vehicle retractable step and the dashboard of the vehicle, or the area in the proximity of the operator of the vehicle, for providing a position indication of the step position.

Various systems of step deployment for motor vehicles are known in the art, but nowhere in the prior art is it shown or suggested to implement an auxiliary alarm system for retractable steps, which operates independently of the step mechanism.

### SUMMARY OF THE INVENTION

Accordingly, it is an objective of the invention to provide a warning alarm system for retractable motor vehicle steps, which utilizes step position and vehicle status sensors to detect hazardous situations and activate an audible or visible alarm by analyzing the logic sequence of sensor feedback.

It is a further objective of the invention to provide a warning alarm system for retractable motor vehicle steps, which can be used with manually, operated retractable steps.

It is yet another objective of the invention to provide a warning alarm system for retractable motor vehicle steps, which can be used in combination with automatic retractable step deployment systems to provide additional protection against hazardous situations.

In accordance with the above objectives, a system for activating a hazardous situation alarm in a motor vehicle having retractable steps comprises a processor coupled to an alarm means, a door sensor, at least one vehicle status sensor, retracted and extended step position sensors. Although not limited thereto, the retracted and extended step position sensors are illustrated as being either optical or magnetic reed sensors or contact pin switches. The alarm can be an audible and/or visible alarms that are activated by a driver integrated circuit (IC) that is enabled by a signal from the processor. The door sensor is operable to detect an open door and generate a logic output indicating door position. The vehicle operation status sensor can be coupled to the ignition system or the transmission, and is operable to detect if the vehicle is engaged for motion and generates a logic output indicating vehicle operation status. The retracted step position sensor is positioned to detect if the steps are fully retracted and generate a logic output indicating if the steps are fully retracted or not fully retracted, and the extended step position sensor is positioned to detect if the steps are fully extended and generate a logic output indicating if the steps are fully extended or not fully extended.

An algorithm resident in the memory of the processing means continuously reads the output of the door sensor, the vehicle operation status sensor, and the retracted and extended step position sensors, and sends an enable signal to the driver IC to activate the alarm means if:
1) the logic output of the vehicle operation sensor indicates the vehicle is engaged and the logic output of the retracted step position sensor indicates the steps are not fully retracted;
2) the logic output of the door sensor indicates the door is open and the logic output of the extended step position sensor indicates the steps are not fully extended;
3) the logic output of the retracted step position sensor and the extended step position sensor are both negative for more than ten seconds (an indication that the steps are stuck and not fully retracted or fully extended) and
   a) the logic output of the door sensor indicates the door is open and the steps are only partially extended or retracted, or
   b) the logic output of the vehicle sensors indicate the vehicle is in operation and the steps are only partially extended or retracted.
4) the logic output of the retracted step position sensor and the extended step position sensor are both positive, an impossible state indication that the one or both of the steps sensors or wiring is damaged or has failed.

Other objects and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a schematic illustration of the components of a preferred embodiment of the system of the invention.

FIG. 2 is a side view of a retractable step assembly with sensors attached to a motor vehicle, with the retracted configuration shown in phantom.

FIG. 3 is a logic matrix of the operating logic of the system of the invention.

FIG. 4 is a diagram showing the operative logic of the system of the invention.

FIGS. 5 and 6 illustrate an alternative embodiment in which the operative logic is implemented with configurations of switches and relays.

### DETAILED DESCRIPTION OF THE INVENTION

Although the invention will be described in terms of a specific embodiment, it will be readily apparent to those skilled in this art that various modifications, rearrangements, and substitutions can be made without departing from the spirit of the invention. The scope of the invention is defined by the claims appended hereto.

The term vehicle is defined herein as any conveyance for transporting passengers, goods or apparatus. The vehicle may be self propelled or pulled and/or pushed by another vehicle or means to move the vehicle.

The present invention is a system for activating a perceptible alarm in a motor vehicle or trailer having retractable steps to alert persons in the vehicle or trailer of a potentially hazardous situation. These situations include movement of the vehicle or trailer with the steps not fully retracted, and opening the door of the vehicle or trailer to exit with the steps not fully extended. The warning alarm system of the invention can be used in combination with manually operated retractable steps, motorized retractable steps, or with a fully automated system for extending and retracting the steps. With a fully automated system, the inventive system provides a significant additional, independent safety system.

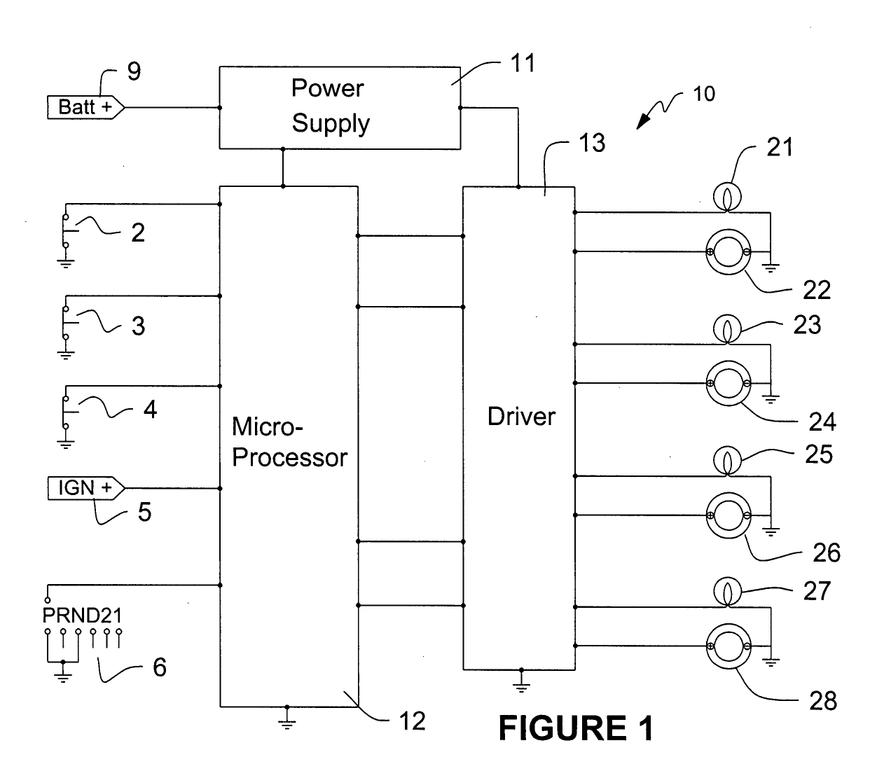

FIG. 1 is a schematic illustration of the components of a preferred, albeit non-limiting, embodiment of a system of the invention. The system includes a microprocessor 12, which is operable to send an enable signal to the driver integrated circuit (IC) 13, which in turn connects the alarm means of 21 through 28 to the power supply 11. An example of a driver IC is National Semiconductor part no. DS2003 High Current/Voltage Darlington Driver. The power supply is in turn connected to the vehicle's battery 9. One of the preferable connection points is the battery hot fuse on the vehicle's fuse panel. The alarm means 21, 23, 25 and 27 are visual indicators such as incandescent lights, LEDs, flashing lights, or other visual indicators. The alarm means 22, 24, 26 and 28 are audible indicators such as buzzers, piezo speakers or other audible indicators.

The FIG. 1 system includes at least one vehicle status sensor, which detects if the motor vehicle is engaged for movement. The vehicles status sensors are coupled to the microprocessor 12 and provide logic inputs indicating the vehicle engagement status. The vehicle status sensors can include ignition power ON detector 5 and transmission gear selector position switch 6 which are coupled to the microprocessor 12. The ignition power ON detector 5 can be implemented with any suitable circuitry. In both the preferred and the alternate embodiments it can be connected to the ignition fuse on the vehicle's fuse panel. In the preferred embodiment the transmission gear selector position switch 6 detects if the vehicle's transmission has been engaged by a driver. The transmission gear selector position switch 6 is closed when the transmission gear selector is placed in the park or neutral positions. In an alternative embodiment, the switch 6 is closed when the transmission is placed in a gear for forward or reverse motion.

The door switch 2 is coupled to the microprocessor 12 to provide a logic. input indicating if the door is open or closed. In the both the preferred and alternate embodiments, the door switch 2 is configured to be closed when the door is open. Alternatively, the door switch 2 could be any suitable sensing means, such as an optical or magnetic reed switch or contact pin switch.

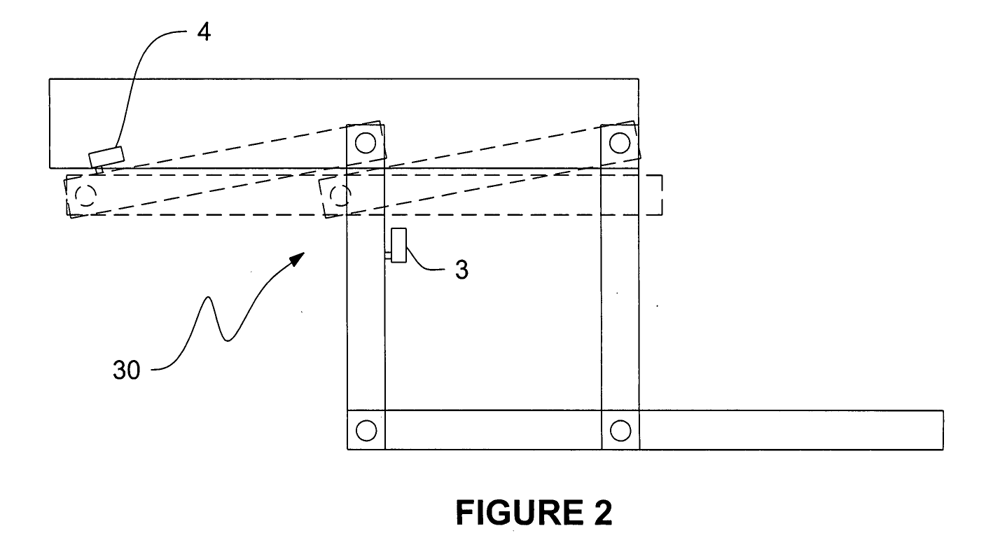

As shown in FIG. 1, extended and retracted step position switches 3, 4 are coupled to the microprocessor 12 and provide logic inputs thereto. FIG. 2 illustrates the approximate placement of the switches 3, 4 on the retractable step assembly 30. The retracted position switch 4 detects if the steps have been fully retracted and generates a logic input indicating if the steps are fully retracted or not fully retracted. The extended step position switch 3 detects if the steps have been fully extended, and generates a logic input indicating if the steps are fully extended or not fully extended. The extended and retracted step position switches 3, 4 can be any suitable sensing means such as contact pin switches or optical or magnetic reed switches.

The steps performed by an algorithm resident in the memory of the microprocessor 12 will now be explained. The microprocessor 12 continuously reads the logic inputs of the door switch 2, the vehicle operation status sensors (the ignition ON sensor 5 and transmission gear selector switch 6), and the extended and retracted step position switches 3, 4. If the logic inputs of the vehicle operation sensors 5 or 6 indicate the vehicle is engaged and the logic input of the retracted step position sensor 3 indicates the steps are not fully retracted, the microprocessor 12 sends an enable signal to the driver IC 13 to activate the alarm means 23, 24. Alarm means 23 and 24 are normally located adjacent the operator of the vehicle, but could also be located anywhere on the vehicle or other device which controls operation of the vehicle. If the door switch 2 indicates the door is open and the logic input of the extended step position switch 4 indicates the steps are not fully extended, the microprocessor 12 sends an enable signal to the driver IC 13 to activate the alarm means 21, 22. The alarm means 21 and 22 are normally located adjacent the door so that someone exiting the vehicle would be notified that the steps were not in their fully extended position. Another set of alarms 21 and 22 could also be located adjacent the operator of the vehicle. High inputs from both the extended and retracted step position switches 3, 4 is an impossible state because it is an indication that the step is fully retracted and fully extended simultaneously. This is, of course, impossible which means that one or both of the step position switches has failed or has been damaged. In this case, a special audible and visual alarm 27, 28 is activated alerting the switches failed condition. Low inputs from both the extended and retracted step position switches 3, 4 for more than ten seconds is an indication that the steps are stuck partially extended due to a mechanical or other failure. In this case, a second special audible and visual alarm 25, 26 is activated alerting the mechanical failure. Alarm means 25, 26, 27 and 28 are normally located adjacent the operator of the vehicle, but could also be located anywhere on the vehicle or other device which controls the operation of the vehicle. In a preferred embodiment all the alarm means are separate, but they could all be connected to a single alarm like a “check engine” light.

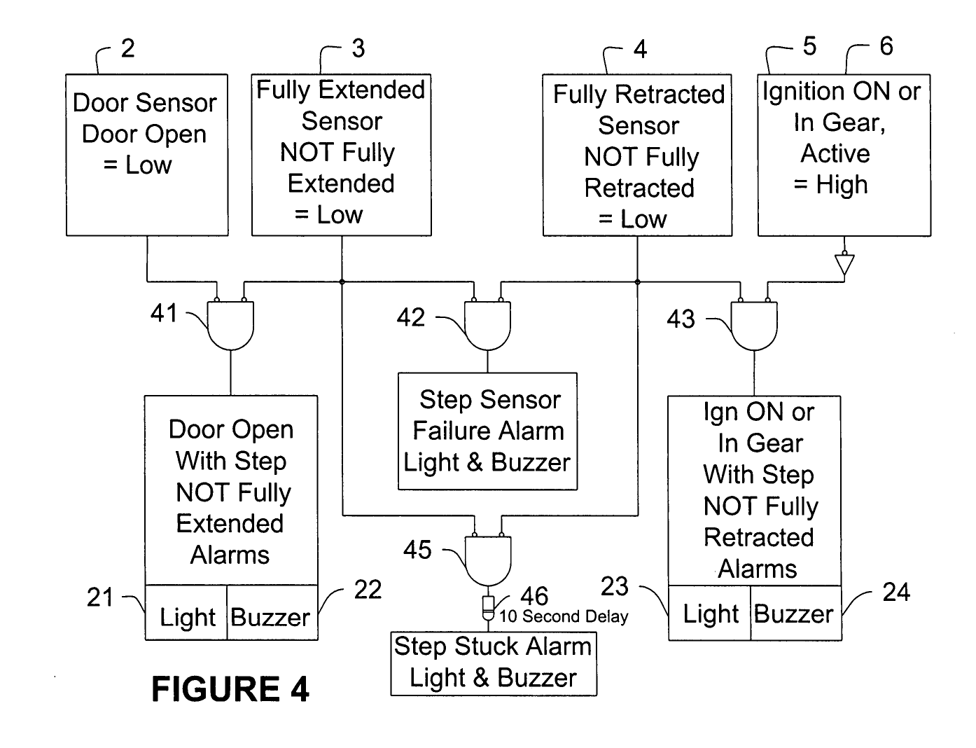

FIG. 4 illustrates the operative logic of the inventive system as implemented by logic gate means. The NAND gate logic means 41 receives logic input from the door switch sensor 2 and the extended step position sensor 3, and activates the alarms 21, 22 if both inputs are low. The NAND gate logic means 43 receives logic input from the vehicle operation status sensors (the ignition ON sensor 5 and/or the transmission gear selector position switch 6) via an inverter, 44 and the retracted position step switch 4 and activates the alarms 23, 24 if both inputs are low. If the AND gate logic means 42 receives high logic inputs from both the extended and retracted step sensors 3, 4 simultaneously a special audible and visual alarm 27, 28 is activated. This is an impossible state indicating that the step is fully extended and retracted at the same time caused by one or both step position switched or wiring being damaged. If the NAND gate logic means 45 receives logic input low from both the extended and retracted step sensors 3, 4 for more than ten seconds, 46, a second special audible and visual alarm 25, 26 is activated indicating that the step is stuck partially extended due to a mechanical or other failure. The logic operations described above can be implemented using the sensors of the system 10 in combination with any desired circuit configuration, which will accomplish the logic functions as described.

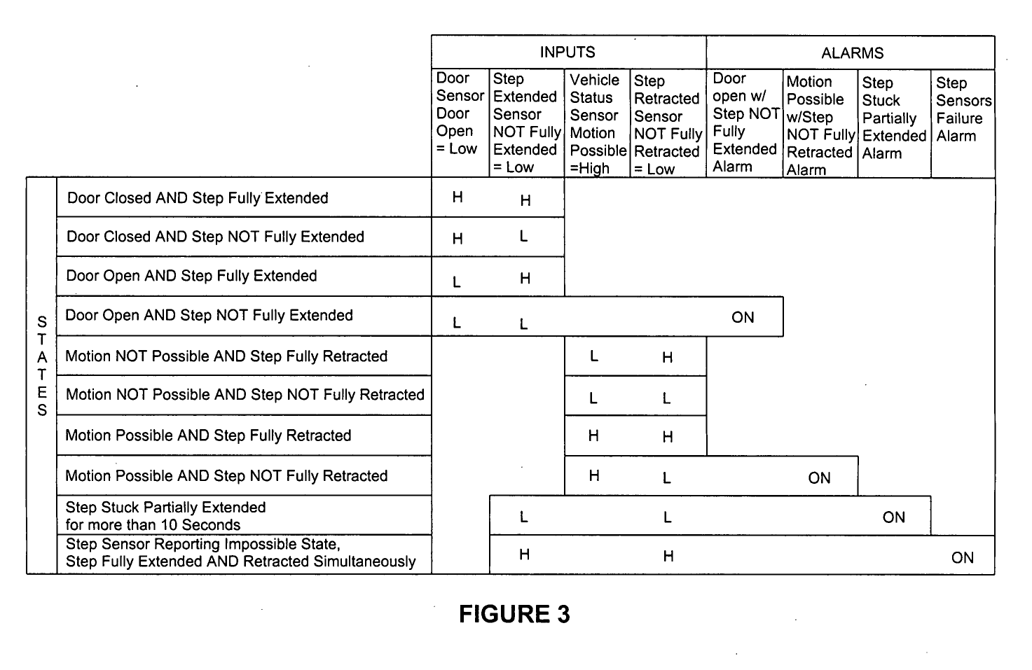

FIG. 3 is a matrix of the operative logic illustrated in FIG. 4. The inputs or sensors are listed along the top of the matrix. The conditions of the vehicle which trigger the alarms are also listed along the top of the matrix. All the possible conditions of the vehicle operation, door position, and step extension or retraction are listed along the left portion of the matrix. An example would be the position of the door and the step being fully extended or not. If the door is closed the door sensor sends a high logic input to the NAND gate 41. If the door is open the sensor sends a low logic input to the NAND gate. If the step is fully extended the step sensor sends a high logic input to the NAND gate and if the step is not fully extended the sensor sends a low logic input to the NAND gate. The NAND gate will only send a signal to activate the alarms if the door is open and the step is not fully extended or when both inputs are low. Another dangerous condition would exist if the vehicle was moving and the step was not fully retracted. This is illustrated in the next set of logic inputs. If motion of the vehicle is not possible because the vehicle transmission is in Park or Neutral and the ignition is off the logic input to NAND gate 43 is low. If vehicle motion is possible because the transmission is in gear and the ignition is on the logic input is high. If the step sensor detects that the step is fully retracted the logic input is high and if the step is not fully retracted the logic input is low. When the vehicle motion logic is high and the step position logic is low the alarm is activated indication a dangerous condition. The vehicle is in motion and the step is not fully retracted.

The bottom two states or conditions on the left side of the matrix illustrate how the step sensors determine that a problem exists with the steps only and the special alarms are activated. If the step sensors detect that the steps are not fully retracted or extended for a period of more than 10 seconds a special alarm is activated. In addition, if the step sensors detect that the step is simultaneously extended and retracted, which is impossible, another special alarm is activated.

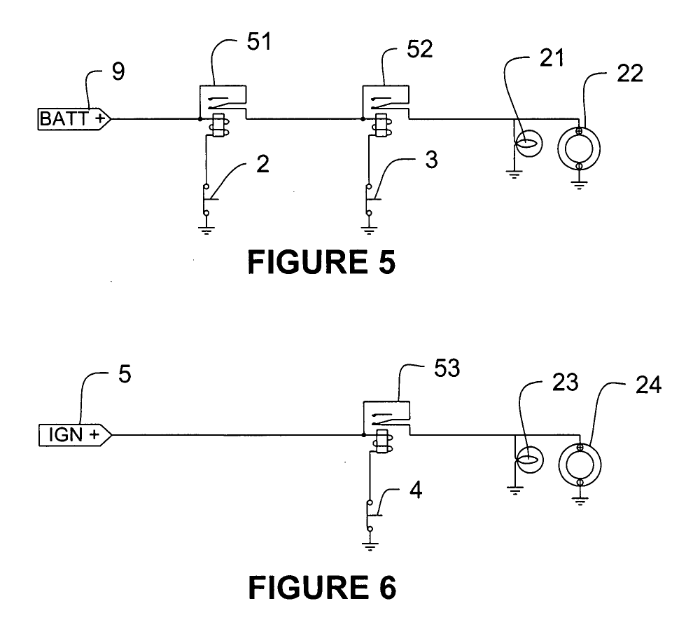

FIGS. 5 and 6 illustrate additional alternative circuit embodiments, which implement the logical function of the system of the invention using contact switches and relays. In FIG. 5, the battery is in a series connection with normally open relays 51 and 52 and the alarm means represented by light 21 and piezo speaker 22. The door switch 2 is coupled to the coil of relay 51. The door switch 2 is positioned and configured to be closed by the action of the door opening, and closing of switch 2 closes the normally open relay 51. The extended step position switch 3 is coupled to the coil of relay 52. The extended step position switch 3 is positioned and configured to be closed when the step is not fully extended, and closing of switch 3 closes the normally open relay 52. If the door is open and the step is not fully extended a circuit path from the battery power to the visual and audible alerts is enabled causing them to be activated. In FIG. 6, a normally open relay 53 is in a series connection with the ignition hot fuse 5 in the vehicle fuse panel and the alarm light 23 and piezo speaker 24. The retracted step position switch 4 is positioned and configured to be closed when the step is not fully retracted, and closing of the switch 4 closes the normally open relay 53. If the ignition is ON and the step is not fully retracted a circuit path from the ignition power to the visual and audible alerts is enabled causing them to be activated.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

I claim:

1. A system for activating a hazardous situation alarm in a vehicle having retractable steps positioned beneath a door and movable from a fully retracted position to a fully extended position, comprising:
a processor means communicating with a resident algorithm;
an alarm coupled to a normally open relay or a driver integrated circuit (IC) which is actuated by an enable signal transmitted by said processor;
said alarm is activated when said normally open relay is closed or said driver IC is actuated;
at least one of the following sensors:
1) a door sensor operable to detect an open door and generate a logic output indicating door position, said door sensor coupled to said processing means wherein said output thereof is readable by said processing means;
2) at least one vehicle operation status sensor operable to detect if the vehicle is engaged for motion and generate logic output indicating vehicle operation status, said at least one vehicle operation status sensor coupled to said processing means wherein said output thereof is readable by said processing means;
3) a retracted step position sensor positioned to detect if the steps are fully retracted and generate a logic output indicating if the steps are fully retracted or not fully retracted, and said step position sensor is coupled to said processing means wherein said output thereof is readable by said processing means;
4) a extended step position sensor positioned to detect if the steps are fully extended and generate a logic output indicating if the steps are fully extended or not fully extended, and said step position sensor coupled to said processing means wherein said output thereof is readable by said processing means;
a resident algorithm constructed and arranged for communication with said processing means, said algorithm operable to perform the steps of:
continuously reading said output of at least one of said door sensor, said vehicle operation status sensor(s), said retracted step position sensor and said extended step position sensor;
sending an enable signal to said driver IC to activate said alarm if:
1) the logic output of a vehicle operation sensor indicates the vehicle is engaged and the logic output of the retracted step position sensor indicates the step is not fully retracted;
2) the logic output of a door sensor indicates the door is open and the logic output of the extended step position sensor indicates the step is not fully extended.

2. The system of claim 1, wherein said algorithm further performs the steps:
sending an enable signal to said driver IC to activate an alarm if the logic output of the extended step position sensor and the retracted step position sensor are both low for more than ten seconds, indicating that the steps are only partially extended, retracted, or stuck and unable to move.

3. The system of claim 1, wherein said algorithm further performs the steps:
sending an enable signal to said driver IC to activate an alarm if the logic of the extended step position sensor and the retracted step position sensor are both high indicating that the step is fully extended and retracted at the same time, this is an indication that one or both of the sensors or the wiring is damaged or defective.

4. The system of claim 1, wherein said at least one vehicle operation status sensor is coupled to the ignition system to detect engagement thereof.

5. The system of claim 1, wherein said at least one vehicle operation status sensor is a normally open relay coupled to the vehicle ignition fuse.

6. The system of claim 1, wherein said at least one vehicle operation status sensor comprises a transmission status sensor operable to generate a logic output indicating transmission engagement.

7. The system of claim 6, wherein said transmission status sensor comprises a two-position switch coupled to the vehicle gear selector and said switch is closed when the selector is in park or neutral and open when the transmission is in gear.

8. The system of claim 1, wherein said extended and retracted step position sensors are contact switches.

9. The system of claim 1, wherein said extended and retracted step position sensors are optical or magnetic reed sensors.

10. The system of claim 1, wherein said alarm comprises a visible alarm.

11. The system of claim 10, wherein said visible alarm comprises a flashing light.

12. The system of claim 1, wherein said alarm is an audible alarm.

13. The system of claim 12, wherein said audible alarm is a piezo speaker.

14. The system of claim 1, wherein said alarm comprises an audible alarm and a visible alarm in combination.

15. The system of claim 2, wherein said alarm comprises an audible alarm and a visible alarm in combination.

16. The system of claim 3, wherein said alarm comprises an audible alarm and a visible alarm in combination.

17. A system for activating a hazardous situation alarm in vehicle having retractable steps positioned beneath a door and movable from a fully retracted position to a fully extended position, comprising:
an alarm operable to generate a perceptible warning signal, said alarm configured to receive logic input wherein said alarm is activated by a high logic input and deactivated by a low logic input;
at least one of the following sensors:
a first sensor operable to detect an open door and generate a first logic output wherein said output is low when the door is open and high when the door is closed;
a second sensor operable to detect vehicle operation status and generate a second logic output wherein output is high if the vehicle is engaged for motion and low if the vehicle is not engaged;
a third sensor operable to detect if the step is fully extended and generate a third logic output wherein said output is high if the step is fully extended and low if the step is not fully extended;
a fourth sensor operable to detect if the step is fully retracted and generate a fourth logic output wherein said fourth output is high if the step is fully retracted and low if the step is not fully retracted;
a first NAND gate logic means receiving input from said first and third logic outputs, said output of said first NAND gate logic means coupled to said alarm;
a second NAND gate logic means receiving input from said second and fourth logic outputs, said output of said second NAND gate logic means coupled to said alarm;
a third AND gate logic means receiving high inputs from said third and forth logic outputs; said output of said third AND gate logic means coupled to an alarm; and
a fourth NAND gate logic means receiving low inputs from said third and forth logic outputs; said output of said fourth NAND gate logic will pass through a ten second delay means and then be coupled to an alarm.

18. The system of claim 17, wherein said second sensor is coupled to the ignition system to sense engagement thereof.

19. The system of claim 17, wherein said second sensor is coupled to the vehicle transmission to sense engagement thereof.

20. The system of claim 17, wherein said third and fourth sensors are contact switches.

21. The system of claim 17, wherein said third and fourth sensors are optical or magnetic reed sensors.

22. The system of claim 17, wherein said alarm is a visible alarm.

23. The system of claim 22, wherein said visible alarm comprises a flashing light.

24. The system of claim 17, wherein said alarm is an audible alarm.

25. The system of claim 17, wherein said alarm comprising an audible alarm and a visible alarm in combination.

26. A system for activating a hazardous situation alarm in a vehicle having retractable steps positioned beneath a door and movable from a fully retracted position to a fully extended position, comprising:
a first sensor operable to detect an open door and close a first switch when said door is open;
a second sensor operable to detect if the step is fully extended and close a second switch when the step is not fully extended;
an alarm operable to generate a perceptible warning signal when said first and said second switches are closed.

27. A system for activating a hazardous situation alarm in a vehicle having retractable steps positioned beneath a door and movable from a fully retracted position to a fully extended position, comprising:
a first sensor operable to detect the operating status of a vehicle and close a first switch when an ignition switch is in its operational position;
a second sensor operable to detect if the step is fully retracted and close a second switch. when the step is not fully retracted;
an alarm operable to generate a perceptible warning signal when said first and said second switches are closed.
